(19) United States
(12) Patent Application Publication
(10) Pub. No.: US 2007/0251516 A1
(43) Pub. Date: Nov. 1, 2007

(54) Precision slicing of large work pieces

(76) Inventors: Albert Roth Nieber, Corning, NY (US); Charles Michael Darcangelo, Corning, NY (US); Jeffrey Matthew Clark, Corning, NY (US); William R. Angell IV, Painted Post, NY (US)

Correspondence Address: CORNING INCORPORATED, SP-TI-3-1, CORNING, NY, 14831, US

(21) Appl. No.: 11/413,679

(22) Filed: Apr. 28, 2006

(51) Int. Cl. B28D 1/08

(52) U.S. Cl. 125/21

(57) ABSTRACT

Disclosed is a process capable of precision slicing substrates with a dimension in the linear direction of at least I meter, comprising the following steps: (I) affixing the work piece to a stage; (11) providing multiple essentially parallel, essentially straight wires having a diameter in the range from about 100 μm to about 600 μm, and allowing the multiple wires to contact the surface of the work piece; (III) allowing the multiple wires to travel in linear directions, optionally with cutting slurry dispensed thereon; and (IV) allowing the multiple wires to move in the slicing directions relative to the work piece; wherein in step (IV), the multiple wires maintain essentially straight and essentially parallel to each other. The process can be used for slicing silica glass substrates having a diameter large than 2 meters in producing slices thereof with a high surface flatness and a low thickness variation.

### FIELD OF THE INVENTION

The present invention relates to cutting and slicing of large work pieces. In particular, the present invention relates to precision slicing of large glass or glass-ceramic work pieces by using a wire saw comprising multiple thin wires. The present invention is useful, for example, in the precision slicing of large silica glass work pieces in the production of large, thin silica glass pieces for use in the production of large-size imagemask substrates.

### BACKGROUND OF THE INVENTION

Wire saws are known as tools for cutting solid work pieces. Typically, in a wire saw, a thin wire or multiple thin wires, with impregnated abrasive particles or with the aid of abrasive particles dispersed in cutting slurries that travel with the wires, is placed in contact with the work piece to be sliced, and allowed to move relative to the work piece under a predetermined pressure. By virtue of the friction between the abrasive particles and the work piece and the resulting cutting effect of the abrasive particles, certain parts of the work piece are removed, slots are formed therein, whereby the work piece is sliced into multiple pieces. Precision slicing of solid objects have been realized in the prior art, but only with respect to relatively small pieces of work pieces, such as those less than 30 cm in diameter.

For example, U.S. Pat. No. 5,758,633 discloses a wire sawing device for precision cutting of semiconductor materials comprising a plurality of sawing wires. The sawing device includes parallel wires supported by wire guide cylinders moving with alternating or continuous movement. The cylinders each include a rotatable sleeve turning about a fixed shaft. There is thus obtained a better distribution of the loads applied to the rotating material, a decrease in heat sources, an improvement of the precision of sawing and a greater facility for disassembly and maintenance. However, it is disclosed in this patent reference that the device was designed for cutting semiconductor ingots such as single-crystalline silicon, GaS, InP, GGG (gadolinium-galium garnet), synthetic sapphire and the like, for the production of semiconductor chips and other devices. These materials to be sliced typically do not have sizes exceeding 50 cm in diameter. The sawing device disclosed in this reference obviously cannot be used for precision sawing of glass and glass-ceramic bulks having a size over 1 meter in diameter.

Recently, with the strong growth in the LCD TFT display market, there is a growing demand of large, thin glass plates having a diameter over 1 meter in the production of imagemasks for the manufacture of LCD TFT panels. Many of the thin glass plates needed cannot be produced by using traditional glass plate manufacture method, such as rolling and floating, but must be produced by slicing large glass work pieces having a diameter of over I meter and a thickness in tens of centimeters, followed by precision polishing of the surfaces of the sliced glass plates.

The large glass work pieces, especially those made of silica produced by flame hydrolysis processes, are very expensive to begin with. Therefore, it is highly desired that the slicing process therefor has a yield as high as possible and a material loss as low as possible. It is also highly desired that the surface of the as-sliced plates has a low roughness to reduce down-stream lapping and polishing work. Furthermore, for those precision glass plates to be used as imagemask substrates, high surface flatness and thickness uniformity are required. Thus the precision of the slicing process is highly desired as well. Last but not least, since the large glass work pieces are bulky, they are heavy, usually weighing several tons. Maneuvering and handling such large and heavy glass pieces in a precision slicing process is a serious challenge. Safety issues, both with respect to the protection of the expensive material prior to and after slicing, and with respect to the workers working with it or in its vicinity, are significant and not easy to solve.

Another concern in slicing large size glass work piece is the ability of the wire to travel with sufficient amount of cutting slurry if a cutting slurry is used. Since the wires travel long distances in the direction of cutting, the likelihood of insufficient amount of cutting slurry being brought into the slicing path is very high. Insufficient amount of cutting slurry would result in slow cutting speed and overheating of the sawing wire. These problems are especially pronounced where thin cutting wires are used; yet thin sawing wires are desired for a low material loss.

The process available for slicing such large bulk glass materials hitherto uses a single wire. It results in low yield, high material loss, low consistency of thickness and higher surface roughness of sliced pieces, hence substantial post-slicing lapping and polishing is necessary to produce usable thin glass products.

Therefore, there is a genuine need for a process capable of precision slicing large glass pieces. The present invention satisfies this need.

### SUMMARY OF THE INVENTION

Accordingly, the present invention provides a process capable of precision slicing work pieces having a dimension in the linear direction of at least 1 meter, comprising the following steps:

(I) affixing the work piece to a stage;

(II) providing multiple essentially parallel, essentially straight wires having a diameter in the range from about 100 μm to about 600 μm, and allowing the multiple wires to contact the surface of the work piece;

(III) allowing the multiple wires to travel in linear directions, optionally with cutting slurry dispensed thereon; and

(IV) allowing the multiple wires to move in the slicing direction relative to the work piece;

wherein in step (IV), the multiple wires maintain essentially straight and parallel to each other.

According to certain embodiments of the process of the present invention, in step (II), the multiple wires have essentially the same diameter.

According to certain embodiments of the process of the present invention, in step (II), the multiple wires are different segments of a single continuous wire. In certain specific embodiments, the single wire is supplied from a wire supply spool at the starting end and received by a wire receiving spool at the other end. In certain embodiments, in steps (II), (III) and (IV), part of the wire is constantly being recycled by reversing the linear direction of the wires.

According to certain embodiments of the process of the present invention, in step (II), the wires are kinked or otherwise having depressions for holding cutting slurry therein.

According to certain embodiments of the process of the present invention, in step (III), the wires travel at essentially the same linear speed.

According to certain embodiments of the process of the present invention, in step (II), the multiple wires provided do not comprise abrasive particles per se, and in step (III), a cutting slurry is dispensed on the surface of the multiple wires and allowed to travel with the wires in the linear directions.

According to certain embodiments of the process of the present invention, in step (III), a cutting slurry is dispensed on the multiple wires, said cutting slurry comprising abrasive particles selected from the group consisting of SiC, diamond, CBN, sapphire, Al₂O₃, CeO₂, and mixtures thereof

According to certain embodiments of the process of the present invention, the process results in a kerf loss of less than about 20%, in certain embodiments less than about 10%, in certain other embodiments less than about 5%.

According to certain embodiments of the process of the present invention, the spacing between adjacent wires is essentially the same, and remains constant during the slicing process.

According to certain embodiments of the process of the present invention, the temperature of the wires is maintained within a 50° C. range during the slicing process.

In certain embodiments of the process of the present invention, the linear directions are essentially perpendicular to the slicing direction.

In certain embodiments of the process of the present invention, a glass plate produced with both sides in contact with sawing wires during the slicing process has a thickness variation of less than 400 μm, in certain embodiments less than 200 μm, in certain other embodiments less than 100 μm.

In certain embodiments of the process of the present invention, a glass plate produced with both sides in contact with sawing wires during the slicing process has a surface flatness of less than 400 μm, in certain embodiments less than 200 μm, in certain other embodiments less than 100 μm, still in certain other embodiments less than 40 μm.

In certain embodiments of the process of the present invention, the glass plates produced with both sides in contact with sawing wires during the slicing process have average thickness variation of less than 400 μm, preferably less than 200 μm, more preferably less than 100 μm.

In certain embodiments of the process of the present invention, the glass plates produced with both sides in contact with sawing wires during the sawing process have a diagonal size of over 800 mm.

In certain embodiments of the process of the present invention, the glass plates produced with both sides in contact with sawing wires during the sawing process have a surface flatness over diagonal size ratio of less than about 1×10⁻⁴, in certain embodiments less than about 8×10⁻⁵, in certain other embodiments less than about 5×10⁻⁵, in certain embodiments less than about 2×10⁻⁵, in certain other embodiments less than about 1×10⁻⁵.

In certain embodiments of the process of the present invention, the position of the multiple wires are determined by guiding grooves of wire guides placed on both sides of the work piece to be sliced.

In certain embodiments of the process of the present invention, the surface of the wire guides upon which the sawing wires rest are coated with polyurethane.

In certain embodiments of the process of the present invention, in step (IV), the wires travel downwards from the top of the work piece to the bottom thereof. In certain other embodiments, in step (IV), the wires travel upwards from the bottom of the work piece to the top thereof.

In certain embodiments of the process of the present invention, in step (I), only the bottom side of the work piece is affixed to a stage. In certain other embodiments, the upper side of the work piece is affixed to a support as well.

The present invention has the advantage that it is capable of slicing large glass work pieces having a diagonal size of over 1 meter, such as between about 1 and 4 meters. The process of the present invention is capable of low kerf loss, high thickness uniformity among plates and within a single plate, and low surface roughness immediately after slicing.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification.

### BRIEF DESCRIPTION OF THE DRAWINGS

In the accompanying drawings,

FIG. 1 is a schematic illustration of the front view of a large glass work piece being sliced according to the process of the present invention.

FIG. 2 is a schematic illustration of the top plan view of a large glass work piece being sliced according to the process of the present invention.

### DETAILED DESCRIPTION OF THE INVENTION

The present invention may be used to slice work piece made of various materials, such as glass, glass-ceramic, metal, composite materials, plastic, and the like. The illustration of the present invention will be made with reference to the slicing process of large glass work piece, such as those made of silica glass. However, it should be understood that the process of the present invention is not limited to glass material. By choosing the proper wires, and cutting slurries, the process of the present invention can be applied to all types of work piece materials.

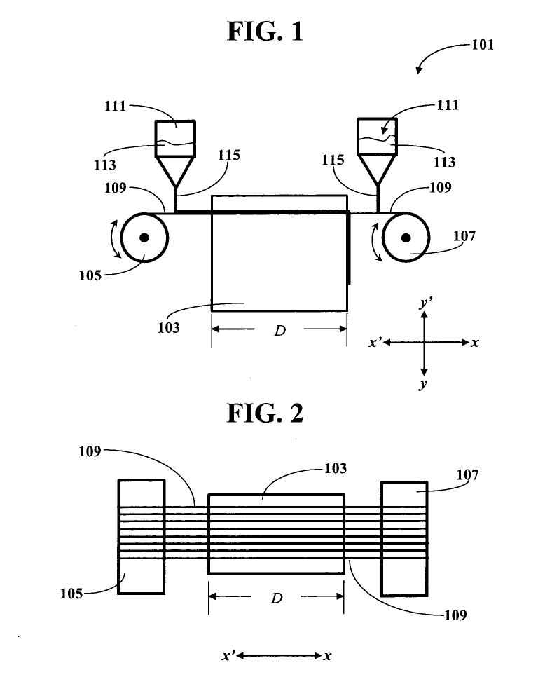

As used herein, “linear direction” means the direction in which the wires extend as they are placed in contact with the work piece. All the wires have two opposite linear directions in which they can travel. Referring to FIGS. 1 and 2, the linear directions include the direction of x and x′. The wires travel through the work piece essentially in a plane. One of the directions in which the wires travel is the linear direction. The other direction in which the wires travel through the work piece is the “slicing direction.” Referring to FIGS. 1 and 2, the slicing directions include the direction of y and y′.

As used herein, a work piece is a piece of material typically made of substances in solid state when being processed by the process of the present invention. The work piece may take various shape, such as cylindrical, rectangular, spherical, and the like. The work piece may be a piece of bulk material with or without internal voids. Thus, the work piece may be a solid glass boule, a honeycomb structure, a tube, and the like.

FIGS. 1 and 2 are schematic illustrations of the process of the present invention in operation. FIG. 1 is a side view, and FIG. 2 is a top plan view. In the slicing device system 101 of FIG. 1, a work piece 103, having a dimension of D in the slicing direction x and x′, is being sliced by multiple wires 109 placed in contact with the work piece 103. The wires 109 are suspended and allowed to extend between two wire guides 107. Wires 109 may travel in either slicing direction x or x′. Cutting slurry 115 is dispensed from slurry storage and dispenser 111 onto the surface of the wires. When the wires travel through the bulk of the work piece in the linear direction, pressure is applied such that it cuts the work piece, and move in the slicing direction y, and at certain times, such as at the end of the slicing, move in the opposite direction y′. FIG. 2 is a top plan view of the same device setup illustrated in FIG. 1. Multiple essentially parallel and essentially straight wires or wire segments 109 are illustrated in this figure. The parallelness and spacing of the wires 109 are ensured and determined by the guiding grooves of the wire guides 107. As can be seen from FIGS. 1 and 2, at the end of the slicing operation, the work piece will be sliced into multiple thin pieces by the wires.

The process of the present invention is capable of slicing large work pieces, such as those made of glass, glass-ceramic, metal, wood, and the like. Referring to FIGS. 1 and 2, such large work pieces have a dimension D in the linear direction of at least one meter, such as 1.5 meters, in certain embodiments 2 meters, in certain other embodiments 3 meters, in certain other embodiments as large as 4 meters. The process of the present invention is particularly advantageous in slicing such work pieces with large dimensions.

In the first step, the work piece to be sliced is affixed to a stage. It is recommended, though not required, that the surface area of the work piece in contact with the stage has a complementary configuration of the contacting surface area of the stage. That is, if the stage has an essentially flat surface, it is desired that the area of the work piece in contact with the stage is essentially flat. Therefore, for work pieces having an essentially cylindrical shape, if the slicing direction therefor is desired to be orthogonal to the cylindrical axis, it is desired that part of the cylindrical surface of the work piece is cut to form a small flat, planar surface which is to be placed on the stage. If it is required the sliced pieces be circular without a flat side, the stage may be machined to have a concave receiving surface on which the work piece will be placed. As can be imagined, for large glass work pieces weighing on the scale of several tons, it is highly desired that the stage is sturdy, heavy so that it can be stable. In such cases it is preferred that the work piece is placed atop the stage instead of below the stage. Affixing of the work piece to the stage can be effected by, for example, mechanical clamping, screwing, and the like, or by using adhesives, such as epoxy resins. In order to prevent the sliced pieces from falling apart at the end of the slicing process, it is preferred that the work piece is affixed to the stage by using strong adhesives. The adhesives can be removed after the slicing process is terminated by chemical or mechanical means. Part of the stage may be cut into and sacrificed during the slicing process.

Usually, only one side of the work piece, such as the bottom side, or the top side, is affixed to the stage. However, it is not ruled out that the work piece is affixed to a stage underneath, and further stabilized in the upper area by, for example, clamping, screwing, or by using adhesives such as epoxy resins, to certain support means, before step (II) has begun, or after steps (II), (III) or (IV) has begun (i.e., before or after the wires have started slicing into the work pieces). Part or all of the upper support means may be sacrificed where necessary.

In the process of the present invention, multiple wires are provided and allowed to contact the surface of the work piece to be sliced. By “multiple,” it is meant that the wires or segments of wires during slicing total at least 2, in certain embodiments more than 5, in certain other embodiments more than 10, in certain other embodiments more than 20. The total number of the cutting wires or wire segments is not critical to the present invention as long as it is more than 2. The actual number may differ and can be adjusted by one of ordinary skill in the art depending on the size of the work piece to be sliced, the dimension, especially the desired thickness of the slices to be produced, and the like.

The wires used in the process of the present invention typically have a diameter of about 100 to 600 μm. The wires are held to be essentially parallel to each other, desirably in essentially the same plane. Tension is applied to the wires such that they are essentially straight during the whole cutting process. In order to obtain high surface flatness of the sliced pieces, keeping the wires essentially straight during the cutting process is essential. Wires with a diameter larger than 600 μm will lead to high kerf loss. As used herein, “kerf loss” means the weight percentage of material lost from the work piece during the slicing operation. Wires with a diameter less than 100 μm are undesirable because they may not be strong enough to withstand the tension applied to keep them straight. Moreover, as discussed supra, if the wires do not comprise cutting particles per se, they must travel with supplied cutting slurry in order to slice the work piece. Due to their small surface area, wires too small tend to carry insufficient amount of cutting slurry. The cutting slurry serves dual functions: cutting by friction and cooling the wires. Thus thin wires may overheat and break due to the insufficient amount of slurry and less than effective cooling effect thereof. In order to carry more cutting slurry or cooling fluid, it is highly desired that the wires are kinked or otherwise comprise a plurality of surface irregularities (such as depressions), especially where the work piece has a large dimension in the linear direction. Although it was not thought that kinked wires would be particularly suitable for slicing processes where high surface flatness and thickness homogeneity is required, the present inventors discovered that kinked wires could be used to produce sliced glass plates with the surface attributes described infra, and, in fact exhibited an enhanced ability in transferring abrasive slurry.

As mentioned supra, the cutting wires may comprise abrasive (cutting) particles per se impregnated therein. Such abrasive particles may be, for example, SiC, diamond, sapphire, CeO₂, Al₂O₃, CBN (cubic boron nitride), and the like, impregnated and/or embedded in the wires. If these wires are used, cooling fluid should be used during slicing. Cooling fluid may be supplied to the wire surface just as the cutting slurry is as illustrated in FIGS. 1 and 2 and described supra. Alternatively, typical steel wires without abrasive particles impregnated may be used. Because these wires may be less hard than the materials such as silica, other glass or glass-ceramic materials of the work piece to be sliced, they cannot cut into those work pieces per se. Thus, a cutting slurry comprising abrasive particles dispersed therein must be used. Such abrasive particles may be SiC, SiN, diamond, sapphire, CeO₂, Al₂O₃, CBN and combinations thereof. It is highly desirable that the particles are evenly distributed in the cutting slurry. The size and load of the abrasive particles in the cutting slurry may vary. Typically, larger size and higher load result in higher cutting speed at a given wire speed and wire pressure. If high surface smoothness of the sliced pieces is desired (such is the case of the production of LCD imagemask substrates), it is desired that abrasive particles having small diameters are employed in the cutting slurry.

It is generally desired that the wires have essentially the same size, essentially the same speeds in both the linear directions (though the directions of the velocities thereof may differ and may be opposite to one another) and the slicing directions. It is also highly desired that the wires have essentially the same tension during slicing. By “essentially the same size,” it is meant that the diameters of the wires are within the average size ±25% thereof, alternatively within the range of average size ±10% thereof. During the slicing process, because the wires may have been subjected to different degree of wear and tear, their actual sizes may vary, but generally are desired to be within the ranges described above.

It has been found that the process of the present invention is capable of very low kerf loss, generally lower than about 20%, in certain embodiments lower than about 10%, in certain other embodiments lower than about 5%. The low kerf loss is realized by the relatively small diameter of the wires, the essentially linear traveling paths in the linear directions of the wires during slicing, little deviation of the traveling paths in the linear directions of the wires during slicing, tight guiding of the movement of the wires, the size of the abrasive particles, temperature of the cutting wires, among others. Thus the process of the present invention has the advantages of high yield. It is desired that the temperature of the wires are maintained within a 50° C., in certain embodiments within 30° C., in certain other embodiments within 20° C., in certain other embodiments within 10° C., during the slicing process. The temperature range as mentioned means the difference between the highest and lowest temperatures.

As mentioned supra, the process of the present invention is capable of producing sliced plates with high thickness uniformity (thus high surface parallelness of the two major sliced surfaces of the pate) across the plate, even when the plate has large dimension over 1 meter in diameter. Prior to the invention disclosed herein it was thought that due to the long distance between the wire guides, wire travel paths may deviate from being linear and change from time to time during the slicing process, resulting in uneven plate thickness across the plate surface. The present inventors found that by choosing the wire size as described above, and by tightly controlling the guiding function of the wire guides as well as the tension in the wires, the travel direction of the wires at different time of the slicing process, as well as the distances between the wires can be maintained substantially constant. The result of such control is high parallelness of the major sliced surfaces of the plate and high thickness uniformity across the plate surfaces.

In order to obtain uniform plate thickness among different sliced plates during a single slicing operation and multiple slicing operations, it is important to control the spacing between the adjacent wires. The average thickness of a sliced plate is determined by the distance between adjacent wires. Thus, the more uniform the distances between adjacent wires, the more uniform the average thicknesses of sliced plates. The distance between adjacent wires is determined by the distance between the adjacent guiding grooves on the wire guides. Thus, in order to obtain a high thickness homogeneity across a sliced plate, it is highly desired that the spacing between adjacent wires are maintained essentially constant during the slicing process. This requires in most cases that the tension in the wires are maintained essentially constant as well during the slicing process.

Therefore, in order to obtain high thickness evenness among plates, high thickness uniformity within a single plate, it is important that the distance between the guiding grooves of the wire guides are precisely controlled, and that the dimension of the guiding grooves remain essentially unchanged during the slicing operation. Thus, it is desirable that the wire guides, especially the guiding grooves, are coated with a hard material that is essentially not subject to significant deformation either due to pressure or due to abrasion. Such material can be, for example, polyurethane polymers.

The multiple cutting wires can be separate and stand-alone wires supplied, received and controlled by separate mechanical and/or electronic mechanisms. In this case, it is important that the wire size, velocity, and the like, are essentially the same if high uniformity in plate thickness, flatness, and the like, are desired. The movement of the wires needs to be highly synchronized if multiple independent wires are used.

In one particularly useful embodiment of the process of the present invention, the cutting wires are merely differing segments of a single, continuous wire. Thus, the wire is supplied from a single wire spool and received by a single wire spool. The single wire, by winding on the guiding grooves of the wire guides, provide multiple cutting wire segments that can cut simultaneously. The adjacent wire segments may move in the same linear direction or in opposite linear directions at any given time. The single wire may move in a single direction all the time during the cutting process. The used wire may be recycled at the end of the operation by reversing the linear direction. Alternatively, the single wire may move in multiple directions during the cutting process. That is, the wire may move to the right for about 10 meters, then reversed for about 9 meters, then reversed again for about 10 meters, then reversed again for about 9 meters, and the like. The net effect of this in-process recycling is that in a single cycle a much shorter (about 1 meter shorter, for example) segment of wire is used up in a single movement cycle, thus a single spool of wire can be used for much longer.

The process of the present invention is capable of producing thin glass plates having thickness variation across the major surfaces of less than about 400 μm, in certain embodiments less than about 200 μm, in certain other embodiments less than about 100 μm, in certain other embodiments less than about 50 μm. The process of the present invention is capable of producing thin glass plates having variation of average thickness among a plurality of plates of less than about 400 μm, in certain embodiments less than about 200 μm, in certain other embodiments less than about 100 μm, in certain other embodiments less than about 50 μm.

The process of the present invention is capable of producing thin glass plates with both sides in contact with sawing wires during the slicing process having a surface flatness of less than 400 μm, in certain embodiments less than 200 μm, in certain other embodiments less than 100 μm, in certain other embodiments less than 40 μm.

The process of the present invention can be advantageously used in the production of sliced plates having a diagonal size of over 800 mm. By “diagonal size”, it is meant the longest distance between points within a plane of a major surface of a sample plate. Therefore, for a plate having a rectangular shape, the diagonal size is the length of the diagonal line of the major surface. For a plate having a circular major surface, the is diagonal size is the diameter of the circle. In such large plates, in certain embodiments, the overall flatness over diagonal size (both with the same unit) ratio of the sliced plates is less than about 1×10⁻⁴, in certain embodiments less than about 8×10⁻⁵, in certain other embodiments less than about 5×10⁻⁵, in certain other embodiments less than about 2×10⁻⁵, in certain other embodiments less than about 1×10⁻⁵, before any further lapping or polishing of the plates.

As mentioned supra, in order to obtain a high thickness homogeneity of the sliced plates, as well as a high surface flatness of the sliced plates, it is highly desired that the wires in contact with the work piece are maintained essentially straight during the whole slicing process. By “essentially straight,” it is meant that the bow of the individual wires are less than about 15% of the width of the work piece with which the wire has direct contact with, preferably less than about 10%, in certain embodiments preferably less than about 5%. Thus, if the total length of the wire in contact with the work piece is LW, and the width of the location at which the slicing occurs is W, the amount of bow of the wire is (LW−W). Maintaining the wire essentially straight means that the ratio LW−W/W×100% is maintained less than about 15%, preferably less than about 10%, in certain embodiments preferably less than 8%. This can be achieved by adjusting the tension of the wires and the guide grooves. A slight bow is required for the slicing to proceed; however, too large a bow would allow the wires to deviate from its intended positions, causing thickness variation and surface flatness reduction.

It will be apparent to those skilled in the art that various modifications and alterations can be made to the present invention without departing from the scope and spirit of the invention. Thus, it is intended that the present invention cover the modifications and variations of this invention provided they come within the scope of the appended claims and their equivalents.

1. A process capable of precision slicing work pieces having a dimension in the linear direction of at least 1 meter, comprising the following steps:
(I) affixing the work piece to a stage;
(II) providing multiple essentially parallel, essentially straight wires having a diameter in the range from about 100 μm to about 600 μm, and allowing the multiple wires to contact the stirs of the work piece, wherein the multiple wires are kinked wires or wires having surface irregularities;
(III) allowing the multiple wires to travel in linear directions, optionally with cutting slurry dispensed thereon; and
(IV) allowing the multiple wires to move in the slicing directions relative to the work piece while maintaining the multiple wires in essentially straight and essentially parallel to each other.

2. A process according to claim 1, wherein in step (II), the multiple wires have essentially the same diameter.

3. A process according to claim 1, wherein in step (II), the multiple wires are different segments of a single continuous wire.

4. A process according to claim 1, wherein in step (II), the wires are kinked or otherwise have depressions for holding cutting slurry therein.

5. A process according to claim 1, wherein in step (III), the wires travel at essentially the same linear speed.

6. A process according to claim 1, wherein in step (II), the multiple wires provided do not comprise abrasive particles per se, and in step (III), a cutting slurry is dispensed on the surface of the multiple wires and allowed to travel with the wires in the linear directions.

7. A process according to claim 1, wherein in step (III), a cutting slurry is dispensed on the multiple wires, said cutting slurry comprising abrasive particles selected from the group consisting of SiC, diamond, sapphire, Al₂O₃, CeO₂, CBN, and mixtures thereof.

8. A process according to claim 1 having a kerf loss of less than about 20%.

9. A process according to claim 1, wherein the spacing between adjacent wires remains essentially constant during the slicing process.

10. A process according to claim 9, wherein the spacing between adjacent wires is essentially the same.

11. A process according to claim 1, wherein the temperature of the wires is maintained within a 50° C. range.

12. A process according to claim 3, wherein the single wire is supplied from a wire supply spool at the starting end and received by a wire receiving spool at the other end.

13. A process according to claim 3, wherein in steps (II), (III) and (IV), part of the wire is constantly being recycled by reversing the linear directions of the wires.

14. A process according to claim 1, wherein the linear directions are essentially perpendicular to the slicing direction.

15. A process according to claim 1, wherein a glass plate produced with both sides in contact with sawing wires during the slicing process has a thickness variation of less than about 400 μm.

16. A process according to claim 1, wherein a glass plate produced within both sides in contact with sawing wires during the slicing process has a surface flatness of less than about 400 μm.

17. A process according to claim 1, wherein the glass plates produced with both sides in contact with sawing wires during the slicing process have average thickness variation of less than about 400 μm.

18. A process according to claim 1, wherein the glass plates produced with both sides in contact with sawing wires during the sawing process have a diagonal size of over about 800 mm.

19. A process according to claim 18, wherein the glass plates produced with both sides in contact with sawing wires during the sawing process have a surface flatness over diagonal size ratio of less than about 1×10⁻⁴.

20. A process according to claim 1, wherein the position of the multiple wires are determined by guiding grooves of wire guides placed on both sides of the work piece to be sliced.

21. A process according to claim 1, wherein during step (IV), the wires travel downwards.

22. A process according to claim 1, wherein during step (IV), the wires travel upwards.

23. A process according to claim 1, wherein in step (I), at least one of a lower end and an upper end of the work piece are affixed.

24. A process according to claim 1, wherein in step (I), the work piece is made of SiO₂ glass.

25. (canceled)
